(19) United States
(12) Patent Application Publication
(10) Pub. No.: US 2003/0141475 A1
(43) Pub. Date: Jul. 31, 2003

(54) Electromagnetic valve for controlling an injection valve of an internal combustion engine

(76) Inventors: Siegfried Ruthardt, Altdorf (DE); Holger Rapp, Hemmingen (DE); Dirk Schoenfeld, Altbach (DE)

Correspondence Address: KENYON & KENYON, ONE BROADWAY, NEW YORK, NY, 10004, US

(21) Appl. No.: 10/204,111

(22) PCT Filed: Nov. 28, 2001
(86) PCT No.: PCT/EP01/13919

(30) Foreign Application Priority Data
Dec. 19, 2000 (DE) 100 63 193.2

(51) Int. Cl. F02M 51/00

(52) U.S. Cl. 251/129.16; 239/585.3

(57) ABSTRACT

A solenoid valve for controlling a fuel injector of an internal combustion engine, including an electromagnet 29, a displaceable armature having an armature plate 28 and an armature pin 27, and a control valve element 25 which is displaced with the armature and which cooperates with a valve seat 24 for opening and closing a fuel discharge channel 17 of a control pressure chamber 14 of the fuel injector 1. The armature plate 28 is mounted on the armature pin 27 so as to be slidably displaceable in opposition to the tensioning force of a restoring spring 35 acting on the armature plate 28 under the influence of the inert mass of the armature plate in the closing direction of the control valve element 25, and is pressed by the restoring spring 35 in its rest state against a stop part 26 attached to the armature pin 27. The stop part 26 is designed to encircle the periphery of the armature pin 27 by more than 180° in a plane perpendicular to the direction of movement of the armature pin.

### BACKGROUND INFORMATION

The present invention relates to a solenoid valve for controlling a fuel injector of an internal combustion engine according to the preamble of claim 1.

Such a solenoid valve, known for example from German Patent Application 197 08 104 A1, is used for controlling the fuel pressure in the control pressure chamber of a fuel injector, such as the injector of a common rail injection system. The fuel pressure in the control pressure chamber controls the movement of a valve piston using which a fuel injector orifice in the fuel injector is opened or closed. The known solenoid valve has an electromagnet situated in a housing part, a displaceable armature, and a control valve element, acted upon by a closing spring in the closing direction and moved together with the armature, which cooperates with a valve seat of the solenoid valve and thereby controls the fuel discharge from the control pressure chamber. A known disadvantage of this solenoid valve is the armature bounce. When the magnet is switched off, the armature together with the control valve element of the closing spring of the solenoid valve is accelerated toward the valve seat in order to close a fuel discharge channel from the control pressure chamber. The impact of the control valve element on the valve seat can result in disadvantageous vibration and/or bouncing of the control valve element on the valve seat, thus impairing the control of the injection process. For this reason, in the solenoid valve known from German Patent Application 197 08 104 A1 the armature is designed in two parts, having an armature pin and an armature plate slidably mounted on the armature pin, so that when the control valve element impacts the valve seat, the armature plate is further displaced against the elastic force of a restoring spring. The restoring spring then brings the armature plate back to its starting position on a stop part on the armature pin. Although the two-part design of the armature reduces the effective decelerated mass and thus the kinetic energy of the armature striking the valve seat which creates the bouncing, the armature plate may disadvantageously rebound against the armature pin after the solenoid valve is closed.

Since an actuation of the solenoid valve results in a defined injection quantity only when the armature plate no longer rebounds, measures are necessary to reduce the rebound of the armature plate. This is particularly necessary for the representation of brief time intervals between a pilot injection and a main injection, for example. In the related art, this object is achieved by the use of an overtravel stop which limits the path length over which the armature plate is able to move on the armature pin. The overtravel stop is mounted in a fixed position in the housing of the solenoid valve, between the armature plate and a slide piece guiding the armature pin. When the armature plate approaches the overtravel stop, a hydraulic damping space is created between the mutually facing flat sides of the armature plate and the overtravel stop. The fuel contained in the damping space generates a force which counteracts the displacement of the armature plate. The rebound of the armature plate is thereby strongly damped. The stop part for the armature plate on the armature pin which faces the electromagnet is designed in the shape of an open annular disk having a U-shaped recess which is pushed in a radial direction onto the armature pin. On its front face directed toward the electromagnet, the armature plate has an annular groove which surrounds the armature pin and which in the assembled solenoid valve laterally encircles the annular disk, so that the annular disk is mounted flush with the front face and is secured from slippage from the armature pin as a result of the annular groove.

During installation of the known solenoid valve, the armature plate must be displaced on the armature pin in the direction of the overtravel stop so that the open annular disk may be laterally pushed onto the annular groove of the armature plate. In order for the armature plate to be displaceable for a sufficiently large distance in spite of the overtravel stop, the overtravel stop has a complicated keyhole-shaped recess which, after a displacement of the overtravel stop, allows a segment of the armature plate to be radially guided through the overtravel stop toward the armature pin. In this position, the annular disk may then be pushed onto the armature plate with its open side. The annular disk is then surrounded by the annular groove in the armature plate and the overtravel stop is displaced into the working position, in which the armature plate cannot pass through the keyhole-shaped recess in the overtravel stop.

### ADVANTAGES OF THE INVENTION

The solenoid valve according to the present invention having the characterizing features of claim 1 enables the manufacture of the solenoid valve to be greatly simplified. The stop part may be advantageously secured against slippage from the armature plate in the radial direction, without the need for retaining elements on the armature plate. The complicated keyhole-shaped recess in the overtravel stop may be omitted and replaced by a simple circular opening. The overtravel stop need not be laterally displaced, since a segment of the armature plate is no longer required to pass through the overtravel stop during installation. This results in greatly simplified installation and significant cost savings. In addition, the solenoid valve may be simplified by designing a front face of the sliding piece guiding the armature pin which faces the armature plate directly as an overtravel stop and by suitably selecting the free slide path of the armature plate on the armature pin by the choice of the thickness of the stop part. The separate manufacture of a disk part as the overtravel stop may be omitted.

Advantageous exemplary embodiments and refinements of the present invention are described by the features characterized in the sub-claims.

Thus, it is particularly advantageous if the armature plate comes to rest on the stop part with its flat front face which is directed toward the electromagnet. The annular groove which in the related art is provided in the armature plate for accommodating the stop part may be omitted. Further cost savings may thus be advantageously realized in the manufacture of the armature plate.

When the electromagnet is actuated, the front face of the armature plate which is attracted by the electromagnet is still separated from the electromagnet by a narrow gap. It is therefore advantageous for the stop part which is fixed to the armature pin to engage in a through recess of the electromagnet. The through recess is also used for accommodation of the valve closing spring and as a fuel return.

In one embodiment, the stop part is designed as an annular or partially annular metallic bushing part and is welded to the armature pin.

In another particularly advantageous embodiment, the stop part is designed as a spring-elastic part which may be snapped onto the armature pin. These measures greatly simplify the attachment of the stop part to the armature pin. The stop part may be advantageously designed as an elastically flexible sickle-shaped disk part having an opening delimited by the two end sections of the sickle-shaped disk part, the inner width of the two end sections being smaller than the diameter of an annular groove in the armature pin in which the sickle-shaped disk part is attached in order to fix its axial position.

### DRAWING

Exemplary embodiments of the present invention are illustrated in the drawing and are explained in the description below.

FIG. 1 shows a cross section through the upper portion of a known fuel injector having a solenoid valve which is known from the related art.

FIG. 2 shows a partial cross section of the known solenoid valve having an overtravel stop which is known from the related art.

FIG. 3 shows a sectional representation through the stop part of the known solenoid valve, perpendicular to the plane illustrated in FIG. 2.

FIG. 4 shows a partial cross section through a solenoid valve according to a first embodiment of the present invention.

FIG. 5 shows a partial cross section through a solenoid valve according to a second embodiment of the present invention.

FIG. 6 shows a sectional representation through the stop part from FIG. 5, perpendicular to the cross-sectional plane illustrated therein.

### DESCRIPTION OF THE EXEMPLARY EMBODIMENTS

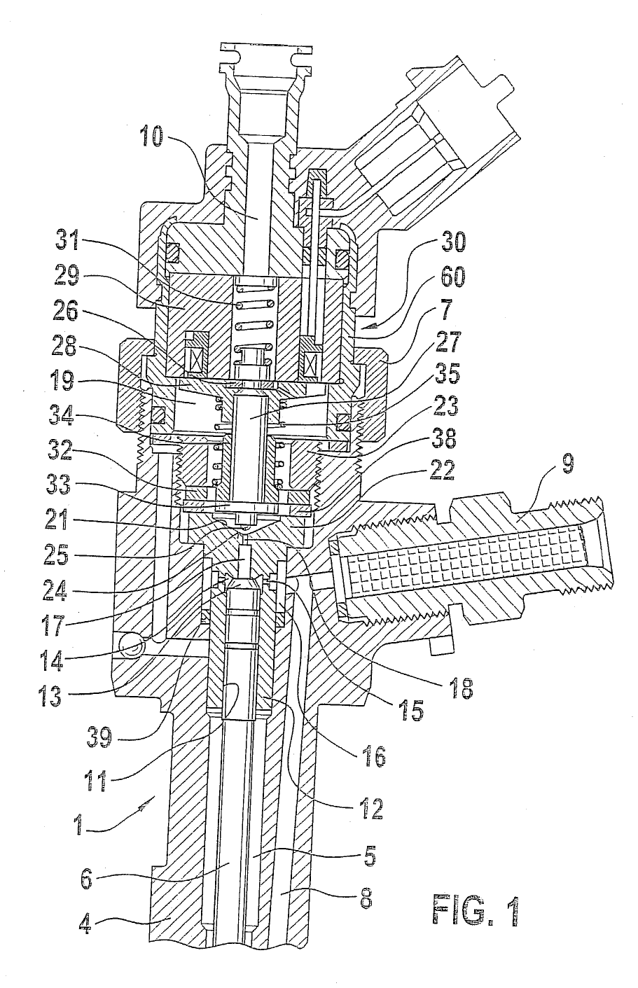

FIG. 1 shows the upper portion of a fuel injector 1 known from the related art which is intended for use in a fuel injection system equipped with a high-pressure fuel accumulator which is continuously supplied with high-pressure fuel via a high-pressure feed pump. The illustrated fuel injector 1 has a valve housing 4 which contains a longitudinal borehole 5 in which a valve piston 6 is situated whose one end acts on a valve needle mounted in a nozzle body (not shown). The valve needle is situated in a pressure chamber which is supplied with high-pressure fuel via a pressure borehole 8. During an opening stroke displacement of valve piston 6, the valve needle is lifted against the closing force of a spring by the high fuel pressure in the pressure chamber which constantly acts on a pressure shoulder of the valve needle. The fuel is injected through an injection orifice, which is then connected to the pressure chamber, into the combustion chamber of the internal combustion engine. Lowering of valve piston 6 causes the valve needle to be pressed into the valve seat of the fuel injector in the closing direction, and the injection process is terminated.

As can be seen in FIG. 1, valve piston 6 is guided at its end facing away from the valve needle in a cylinder borehole 11 which is introduced in a valve piece 12 inserted into valve housing 4. In cylinder borehole 11, front face 13 of valve piston 6 encloses a control pressure chamber 14 which is connected to the high-pressure fuel connection via a supply channel. The supply channel is essentially designed in three parts. A borehole leading radially through the wall of valve piece 12, with the inner walls of the borehole forming an inlet throttle 15 along a portion of their length, is continuously joined to an annular space 16 which peripherally encloses the valve piece, the annular space in turn being continuously joined, via a fuel filter inserted into the supply channel, to the high-pressure fuel connection of a connecting piece 9 which is screwable into valve housing 4. Annular space 16 is sealed with respect to longitudinal borehole 5 by gasket 39. Control pressure chamber 14 is subjected to the high fuel pressure prevailing in the high-pressure fuel accumulator via inlet throttle 15. Coaxial to valve piston 6, a borehole running in valve piece 12 branches off from control pressure chamber 14 and forms a fuel discharge channel 17 provided with an outlet throttle 18 which opens into a pressure relief chamber 19 connected to a low-pressure fuel connection 10, which in turn is connected to a fuel return of fuel injector 1 in a manner which is not further illustrated. The outlet of fuel discharge channel 17 from valve piece 12 is situated in the region of a conically countersunk portion 21 of the external front face of valve piece 12. Valve piece 12 is firmly braced against valve housing 4 in a flange region 22 via a screw element 23.

A valve seat 24 is formed in conical part 21 and cooperates with a control valve element 25 of a solenoid valve 30 which controls the fuel injector. Control valve element 25 is coupled to a two-part armature in the form of an armature pin 27 and an armature plate 28, the armature cooperating with an electromagnet 29 in solenoid valve 30. Solenoid valve 30 includes a housing part 60 which encloses an electromagnet, the housing part being firmly connected to valve housing 4 via screwable connection means 7. In the known solenoid valve, armature plate 28 is mounted on armature pin 27 so as to be dynamically displaceable in opposition to the pretensioning force of a restoring spring 35 under the influence of the inert mass of the armature plate, and in the rest state is pressed by this restoring spring against a stop part 26 attached to the armature pin. With its other end, restoring spring 35 is supported against the housing by a flange 32 of a slide piece 34 which guides armature pin 27, the slide piece being firmly clamped to this flange in the valve housing between a spacing disk 38 placed on valve piece 12 and screw element 23. Armature pin 27, together with armature disk 28 and control valve element 25 coupled to the armature pin, are continuously acted upon in the closing direction by a closing spring 31 supported against the housing, so that control valve element 25 normally rests on valve seat 24 in the closed position. When the electromagnet is energized, armature plate 28 as well as armature pin 27, via stop part 26, are moved toward the electromagnet, thereby opening discharge channel 17 toward pressure relief chamber 19. Between control valve element 25 and armature plate 28, an annular shoulder 33 is situated on armature pin 27 which strikes flange 32 when the electromagnet is energized, thereby limiting the opening stroke of control valve element 25. Spacing disk 38 situated between flange 32 and valve piece 12 is used to adjust the opening stroke.

The opening and closing of the fuel injector is controlled by solenoid valve 30 as described below. Armature pin 27 is constantly acted upon in the closing direction by closing spring 31, so that when the electromagnet is not energized, control valve element 25 rests on valve seat 24 in the closed position and control pressure chamber 14 is closed toward pressure relief side 19, with the result that high pressure which is also present in the high-pressure fuel accumulator builds up very rapidly via the supply channel. The pressure in control pressure chamber 14 generates via the surface of front face 13 a closing force on valve piston 6 and the valve needle connected to it which is greater than the forces acting in the opening direction as a result of the high pressure present. When control pressure chamber 14 is opened toward pressure relief side 19 by the opening of the solenoid valve, the pressure diminishes very rapidly in the small volume of control pressure chamber 14, since the control pressure chamber is connected to the high-pressure side not directly, but instead via inlet throttle 15. As a result, the force from the high-pressure fuel present at the valve needle which acts on the valve needle in the opening direction predominates, so that the valve needle moves upward, thereby opening the at least one injection orifice for injection. However, when solenoid valve 30 closes fuel discharge channel 17, the pressure in control pressure chamber 14 resulting from the fuel continuing to flow through supply channel 15 may build up again, so that the original closing force is present and the valve needle of the fuel injector closes.

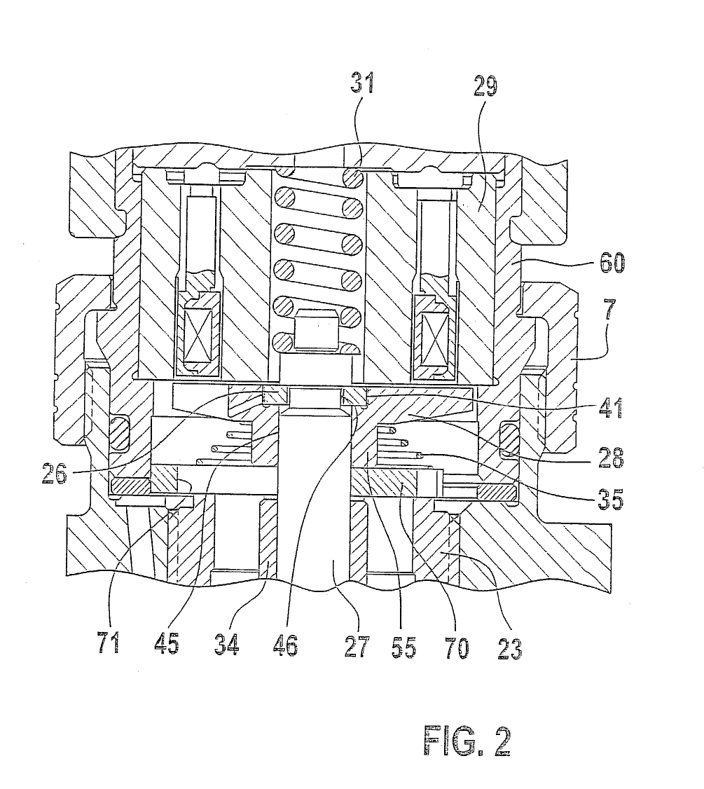

When the solenoid valve closes, closing spring 31 abruptly presses armature pin 27 together with control valve element 25 against valve seat 24. A disadvantageous bounce or rebound of the control valve element arises due to the fact that the impact of the armature pin on the valve seat creates an elastic deformation of the valve seat which has the effect of an energy accumulator, a portion of the energy in turn being transmitted to the control valve element, which then together with the armature pin bounces from valve seat 24. The known solenoid valve shown in FIG. 1 therefore uses a two-part armature having an armature plate 28 which is uncoupled from armature pin 27. Thus, although it is possible to reduce the total mass striking the valve seat, armature plate 28 may disadvantageously rebound. For this reason, approaches are known from the related art which provide for an overtravel stop 70 in the form of a disk situated between armature plate 28 and slide bushing 34, as illustrated in FIG. 2. Overtravel stop 70 limits the displacement path of armature plate 28 on armature pin 27. Rebounding of armature plate 28 is reduced by overtravel stop 70, and armature plate 28 returns more quickly to its starting position on stop part 26. Spacing disk 38, slide piece 34, and overtravel stop 70 are clamped in a fixed position in the solenoid valve housing.

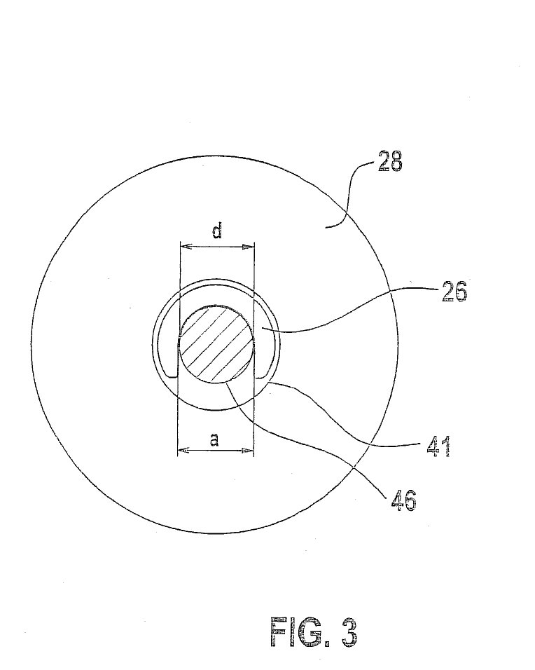

During installation of solenoid valve 30, stop part 26 must be attached to armature pin 27. Stop part 26 is designed in the shape of an open annular disk having a U-shaped recess which is best seen in FIG. 3. Annular disk 26 is pushed into an annular groove 46 of the armature pin, thereby being axially secured in position. Distance a between the two arms of the U-shaped disk is designed to be slightly greater than diameter d of armature pin 27. To enable annular disk 26 to be pushed with its opening onto armature pin 27, armature plate 28 must be displaced downward toward overtravel stop 70. As seen in FIG. 2, disk-shaped overtravel stop 70 has a keyhole-shaped recess 71 for this purpose. Overtravel stop 70 is displaced to the right in FIG. 2. It is then possible to press armature plate 28 downward so that it engages with lower fitting 55 through recess 71. In this position, annular disk 26 may be laterally pushed over the armature pin. Armature plate 28 is then released again and pressed against annular disk 26 by the tensioning force of restoring spring 35. Overtravel stop 70 is now displaced to the left in the end position shown in FIG. 2, and is locked in this position. As can be seen in FIG. 2 and FIG. 3, armature plate 28 has a recess 41 in the shape of an annular groove. When armature plate 28 springs back, recess 41 surrounds annular disk 26 so that the annular disk is also secured to the armature pin in the radial direction. This known approach from the related art requires a special design of overtravel stop 70 and armature plate 28.

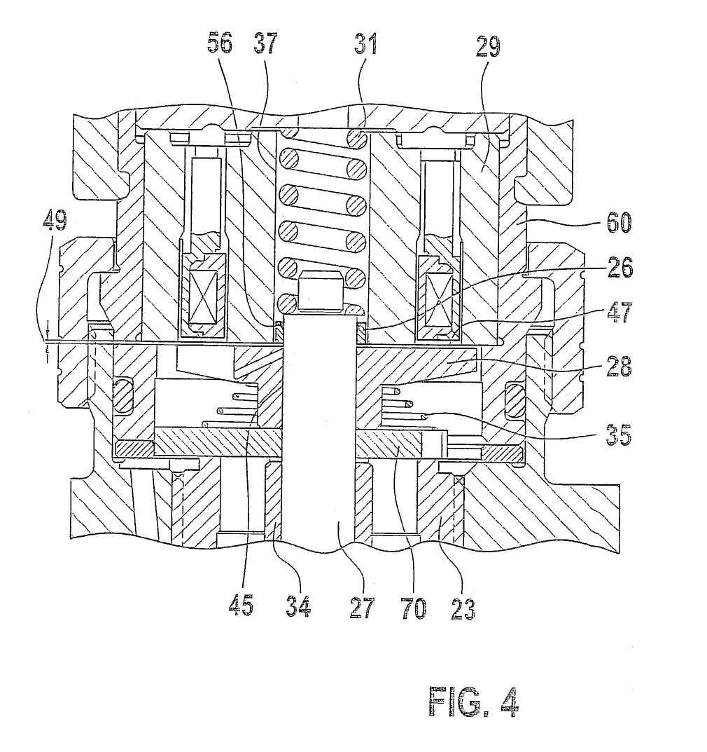

FIG. 4 illustrates a first embodiment of the solenoid valve according to the present invention. Identical parts are denoted by the same reference numbers. The portion shown is installed in solenoid valve 30 instead of the portion shown in FIG. 2. In contrast to the related art, armature plate 28 does not have an annular groove. As in the case of the known solenoid valves, flat front face 47 of armature plate 28 which faces toward electromagnet 29 is separated from the electromagnet by a distance which is not less than minimum distance 49. The minimum distance is maintained by the impact of annular shoulder 33 on slide piece 35. In contrast to the related art, flat front face 47 of armature plate 28 comes to rest directly on a stop part 26 which is designed as a metallic bushing which is pushed over armature pin 27 and is welded to cylindrical lateral surface 45 of the armature pin at points 56. Other types of connections with positive material fit or friction fit are also possible. The bushing is pushed onto the armature pin until the displacement path of the armature plate up to overtravel stop 70 corresponds to the predetermined value. The bushing, which encircles the armature pin by more than 180°, may have an annular or only partially annular design. As can be further seen from FIG. 4, stop part 26 engages in through recess 37 of the electromagnet in which closing spring 31 is also situated. This is necessary so that stop part 26, which is not mounted flush with front face 47 of the armature plate, does not abut against electromagnet 29. As seen in FIG. 3, overtravel stop 70 does not have a keyhole-shaped recess, but instead has only a circular opening through which armature pin 27 passes. The design of the solenoid valve is thus notably simpler and more economical than that of the related art. It is understood that in the embodiment illustrated, overtravel stop 70 need not be provided as a separate disk part, but, for example, may also be formed from the front face of slide piece 35 which faces toward the armature plate.

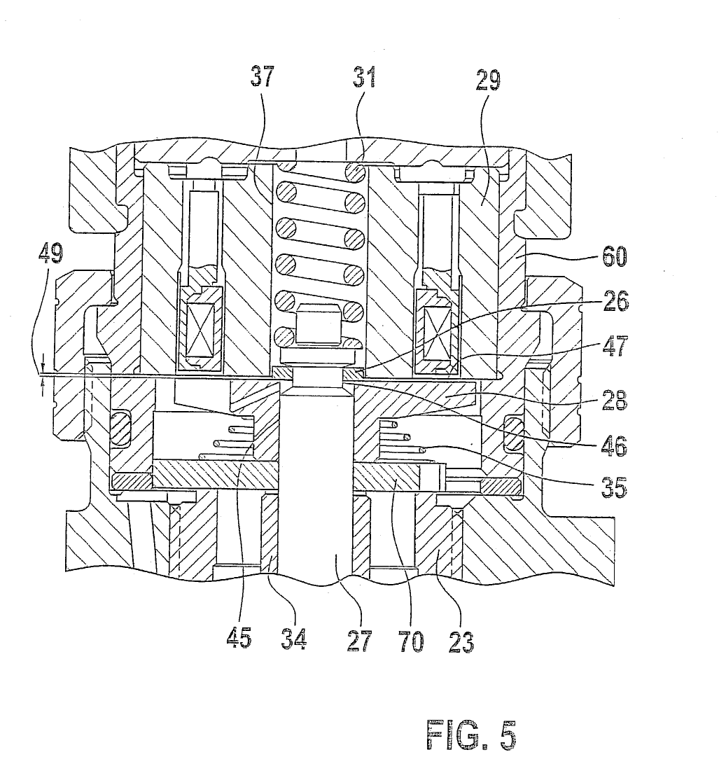

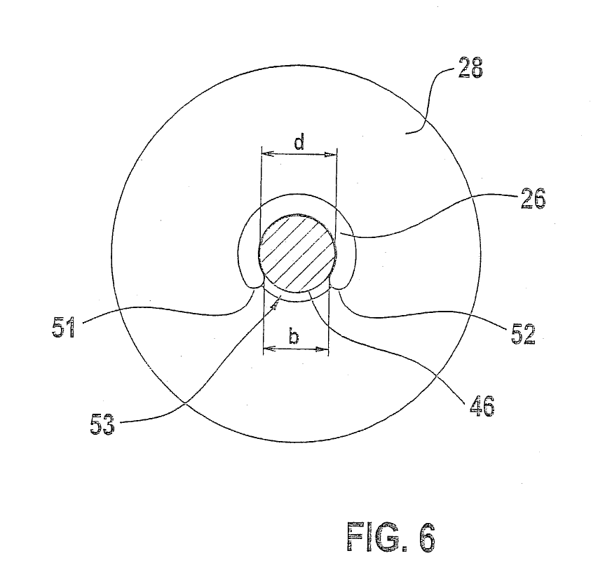

A further particularly advantageous embodiment is illustrated in FIG. 5 and FIG. 6. It can be seen that armature pin 27 is provided with an annular groove 46. Stop part 26 is designed as a spring-elastic part which may be snapped onto the armature pin in the region of annular groove 46. As can be seen best in FIG. 6, spring-elastic part 26 is designed as an elastically flexible sickle-shaped disk part made of metal or another suitable material having an opening 53 delimited by two end sections 51, 52 of the sickle-shaped disk part. Inner width b of two end sections 51, 52 is designed to be smaller than diameter d of annular groove 46 of armature pin 27. Stop part 26 is clipped onto the armature pin in the region of annular groove 46, end sections 51, 52 first being pretensioned against the armature pin and then elastically springing back, thereby encircling the periphery of the armature pin by more than 180° and securing stop part 26 to armature pin 27 in the radial direction. Displacement in the axial direction is prevented by annular groove 46. Front face 47 of armature plate 28 which faces electromagnet 29 has a flat design, and is pressed by the tensioning force of restoring spring 35 in the rest state against sickle-shaped disk part 26 which engages in through opening 37 of the electromagnet. Installation of the stop part is particularly simple because the stop part is merely snapped like a spring clip onto the armature pin. The annular groove in armature plate 28 and the keyhole-shaped recess in overtravel stop 70 are omitted. In this exemplary embodiment, overtravel stop 70 may optionally be formed from the front face of slide piece 35 which faces armature plate 28, instead of being provided as a separate disk part.

What is claimed is:

1. A solenoid valve for controlling a fuel injector of an internal combustion engine, comprising an electromagnet (29), a displaceable armature having an armature plate (28) and an armature pin (27), and a control valve element (25) which is displaced with the armature and which cooperates with a valve seat (24) for opening and closing a fuel discharge channel (17) of a control pressure chamber (14) of the fuel injector (1), the armature plate (28) being mounted on the armature pin (27) so as to be slidably displaceable against the tensioning force of a restoring spring (35) acting on the armature plate (28) under the influence of the inert mass of the armature plate in the closing direction of the control valve element (25), and being pressed by the restoring spring (35) in its rest state against a stop part (26) attached to the armature pin (27), wherein the stop part (26) encircles the periphery of the armature pin (27) by more than 180° in a plane perpendicular to the direction of movement of the armature pin.

2. The solenoid valve as recited in claim 1, wherein in the rest position of the armature plate (28) its flat front face (47) which faces toward the electromagnet (29) and which is separated from the electromagnet by a narrow gap (49) comes to rest on the stop part (26).

3. The solenoid valve as recited in claim 1, wherein the stop part (26) attached to the armature pin (27) engages in a central through recess (37) of the electromagnet (29).

4. The solenoid valve as recited in one of claims 1 through 3, wherein the stop part (26) is attached with a positive material fit to the armature pin (27).

5. The solenoid valve as recited in one of claims 1 through 3, wherein the stop part (26) is attached with a friction fit to the armature pin (27).

6. The solenoid valve as recited in claim 4, wherein the stop part (26) is formed by an annular or partially annular bushing part which is pushed onto the armature pin (27) and is welded to the lateral surface (45) of the armature pin, the bushing part encircling the armature pin by more than 180° and preferably by 360°.

7. The solenoid valve as recited in one of claims 1 through 3, wherein the stop part (26) is designed as a spring-elastic part which may be snapped onto the armature pin (27).

8. The solenoid valve as recited in claim 7, wherein the spring-elastic part (26) is an elastically flexible sickle-shaped disk part having an opening (53) delimited by the two end sections (51, 52) of the sickle-shaped disk part, the inner width (b) of the two end sections (51, 52) being smaller than the diameter (d) of an annular groove (46) in the armature pin (27) in which the sickle-shaped disk part (26) is attached.
